(19) United States
(12) Patent Application Publication
(10) Pub. No.: US 2020/0045876 A1
(43) Pub. Date: Feb. 13, 2020

(54) ACTIVE FLOW TUNING OF SECONDARY HEADER

(71) Applicant: CNH Industrial Canada, Ltd., Saskatoon (CA)

(72) Inventor: Scott D. Noble, Saskatoon (CA)

(73) Assignee: CNH Industrial Canada, Ltd., Saskatoon (CA)

(21) Appl. No.: 16/100,578

(22) Filed: Aug. 10, 2018

(51) Int. Cl. A01C 7/08; A01C 7/10

(52) U.S. Cl. CPC A01C 7/084; A01C 7/102; A01C 7/082

(57) ABSTRACT

A pneumatic distribution system for an agricultural implement, including a plurality of fluid lines including a primary fluid line and at least two secondary fluid lines, and at least one header fluidly coupling the primary fluid line with the at least two secondary fluid lines. The at least one header includes a header body having a fluid inlet fluidly coupled to the primary fluid line and at least two fluid outlets fluidly coupled to the at least two secondary fluid lines, a top cover connected to the header body, an insert located beneath the top cover and associated with the fluid passageway, and at least one actuator operably coupled with the insert and configured for moving the insert to control the airstream.

### FIELD OF THE INVENTION

The present invention pertains to agricultural implements and, more specifically, to agricultural seed planting implements.

### BACKGROUND OF THE INVENTION

Agricultural implements, such as planters, air seeders, or air drills, may be used to simultaneously plant multiple rows of crop material in a field in a uniform and consistent manner. Such implements typically include at least one storage tank, which stores particulate matter such as seed or fertilizer, a pneumatic seed metering system, and multiple row units for opening a trench in the field, depositing the seed in the trench, and closing the trench. The storage tank may be located on the seeding unit itself, as in some air drills, or located on a separate air cart that is either towed behind or in front of the seeder tool. In either configuration, the pneumatic seed metering system fluidly couples the storage tank to the row units so that seed or other particulate matter can be metered and transported in an airstream from the storage tank into the field. The pneumatic seed metering system generally includes a fan coupled to the storage tank and numerous fluid lines, e.g. hoses, interconnected between the storage tank and the row units. The row units may each include an auxiliary seed hopper, as in planters, a cutting disk or hoe for opening a trench in the field, a seed meter disk, a closing disk, and/or a packer roller to pack soil on top of the planted seed.

To increase the numbers of rows being planted, pneumatic seed metering systems of modern air seeders or drills typically have one or more primary fluid lines that are interconnected between the storage tank and multiple secondary fluid lines which then transport the seed or other particulate matter to each row unit. One type of air seeder uses a primary fluid line to transport the seed to a first hollow distributor or manifold that then divides the airstream into a number of secondary streams, which then couple to respective secondary headers. The secondary headers then further divide the airstream and transport the seed or other particulate matter to each row unit. Another type of air seeder uses a mechanical metering roller that is segmented into a number of respective subsections. Each subsection is fluidly connected to respective secondary headers that then further divide the airstream into individual airstreams associated with each row unit.

It is common for the air pressure of the airstreams within the primary and/or secondary fluid lines to differ. For example, if one primary line is longer than another primary fluid line, then the two primary fluid lines will offer differing pressurized airstreams to their respective secondary fluid lines. The secondary header typically cannot compensate the air pressure within each individual secondary fluid line because the secondary header simply evenly splits the primary airstream among its various secondary fluid lines. Hence, the agricultural planting implement may not be able to provide sufficient air pressure among its several row units.

What is needed in the art is a cost-effective device for controlling the fluid pressure within the headers.

### SUMMARY OF THE INVENTION

In one exemplary embodiment formed in accordance with the present invention, there is provided a pneumatic distribution system with a header that has a movable, flow-directing insert and one or more actuator(s) for moving the insert. The actuators can move the insert automatically to vary the product flow rates among the various fluid outlets of the header.

In another exemplary embodiment formed in accordance with the present invention, there is provided a pneumatic distribution system for an agricultural implement, including a plurality of fluid lines including a primary fluid line and at least two secondary fluid lines, and at least one header fluidly coupling the primary fluid line with the at least two secondary fluid lines. The at least one header includes a header body having a fluid inlet fluidly coupled to the primary fluid line and at least two fluid outlets fluidly coupled to the at least two secondary fluid lines. The header body defines a fluid passageway for allowing an airstream to flow therethrough. The at least one header also includes a top cover connected to the header body, an insert located beneath the top cover and associated with the fluid passageway, and at least one actuator operably coupled with the insert and configured for moving the insert to control the airstream.

In yet another exemplary embodiment formed in accordance with the present invention, there is provided a pneumatic distribution system for an agricultural implement, including a plurality of fluid lines including a primary fluid line and at least two secondary fluid lines, and at least one header fluidly coupling the primary fluid line with the at least two secondary fluid lines. The at least one header includes a header body having a fluid inlet fluidly coupled to the primary fluid line and at least two fluid outlets fluidly coupled to the at least two secondary fluid lines. The header body defining a fluid passageway for allowing an airstream to flow therethrough. The at least one header also includes a top cover connected to the header body, a rigid insert located beneath the top cover, slideably connected to the header body, and associated with the fluid passageway, and at least one actuator pivotally coupled with the rigid insert and configured for moving the rigid insert to control the airstream.

In yet another exemplary embodiment formed in accordance with the present invention, there is provided a method for distributing a particulate matter in an agricultural implement. The method includes the step of providing a pneumatic distribution system including a plurality of fluid lines including a primary fluid line and at least two secondary fluid lines and at least one header fluidly coupling the primary fluid line with the at least two secondary fluid lines. The at least one header includes a header body having a fluid inlet fluidly coupled to the primary fluid line and at least two fluid outlets fluidly coupled to the at least two secondary fluid lines. The header body defines a fluid passageway for allowing an airstream to flow therethrough. The at least one header also includes a top cover connected to the header body, an insert located beneath the top cover, connected to the header body, and associated with the fluid passageway, and at least one actuator operably coupled with the flexible insert. The method also includes the steps of maintaining the insert in a neutral position by maintaining a neutral state of the at least one actuator so that the insert evenly divides the airstream, moving the insert into a biasing position by adjusting the at least one actuator so that the insert unevenly divides the airstream, and moving the insert into a restricting position by adjusting the at least one actuator so that the insert at least partially restricts the airstream.

One possible advantage of the exemplary embodiment of the pneumatic distribution system is that the airstream within the header can be actively controlled such that the flow amongst the secondary fluid lines can be dynamically biased and the resistance on the primary fluid line can be altered by the moveable, flow-directing insert of the header.

Another possible advantage of the exemplary embodiment of the pneumatic distribution system is that the moveable, flow-directing insert provides for primary flow balancing, in the absence of upstream baffles or independent fans.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown Like numerals indicate like elements throughout the drawings. In the drawings:

FIG. 1 illustrates a cross-sectional view of a known header for an agricultural planting implement;

FIG. 2 illustrates a cutaway view of an exemplary embodiment of a header for an agricultural planting implement, the header including a flexible insert for adjusting the airstream within header, in accordance with an exemplary embodiment of the present invention;

FIG. 3 is a schematic view illustrating a neutral position of the flexible insert of the header of FIG. 2, in accordance with an exemplary embodiment of the present invention;

FIG. 4 is a schematic view illustrating a biasing position of the flexible insert of the header of FIG. 2, in accordance with an exemplary embodiment of the present invention;

FIG. 5 is a schematic view illustrating a restricting position of the flexible insert of the header of FIG. 2, in accordance with an exemplary embodiment of the present invention;

FIG. 6 illustrates a cutaway view of another exemplary embodiment of a header for an agricultural planting implement, the header including a rigid insert with a main body and a nose moveably connected to the main body in order to adjust the airstream within header, in accordance with an exemplary embodiment of the present invention;

FIG. 7 is a top view of the rigid insert of the header of FIG. 6, in accordance with an exemplary embodiment of the present invention; and

FIG. 8 illustrates a cutaway view of another exemplary embodiment of a header for an agricultural planting implement, the header including a sliding plate for adjusting the airstream within header, in accordance with an exemplary embodiment of the present invention.

### DETAILED DESCRIPTION OF THE INVENTION

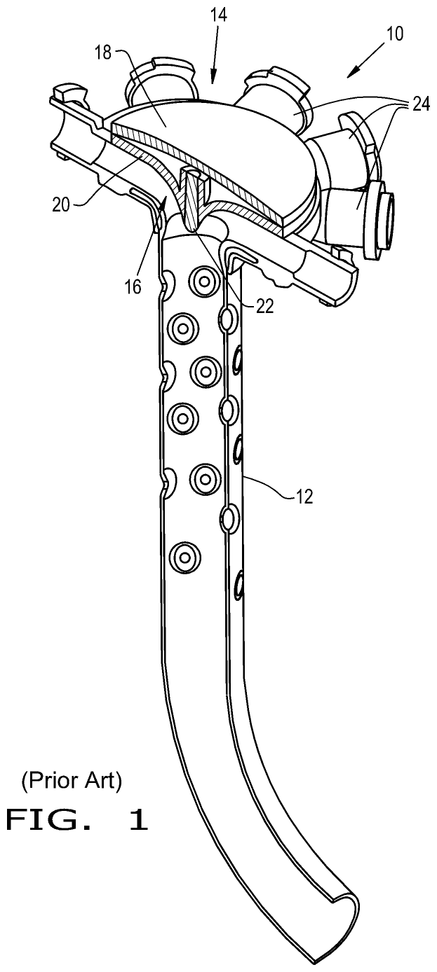

Referring now to the drawings, and more particularly to FIG. 1, there is shown a known distribution system 10 for an agricultural planting implement, such as an air seeder or drill. The agricultural planting implement typically includes a toolbar, row units, a storage tank for storing particulate matter, e.g. seed or fertilizer, therein, and the distribution system 10. The distribution system 10 generally includes multiple fluid lines 12 that fluidly connect the storage tank to the row units, and one or more distribution header(s) 14 which divide a larger airstream into multiple, smaller airstreams respectively associated with the row units. The distribution system 10 may have a primary section with primary fluid lines 12 and a primary header 14 as well as a secondary section with secondary fluid lines 12 and a secondary header 14. The primary and secondary headers 14 can be designed substantially similarly to one another.

The header 14 may include an air inlet 16 connected to a corresponding fluid line 12, a top cover 18, a flow deflecting insert 20 with a center through-hole (unnumbered) and a nose 22 disposed therein, and multiple fluid outlets 24 disposed radially about the center axis of the distribution header 14. Additional fluid lines (not shown) are coupled with the fluid outlets 24. The flow deflecting insert 20 and the nose 22 are composed of a rigid polymer that is resistant to abrasion.

As the airstream exits the fluid line 12 and enters through the air inlet 16, the airstream is divided and redirected by the flow deflecting insert 20, and then each divided airstream exits through a respective fluid outlet 24. In more detail, the nose 22, which is disposed concentrically with the center axis of the fluid line 12, initially divides the vertically disposed airstream; and further, in conjunction with the flow deflecting insert 20, redirects the vertically disposed airstream into multiple evenly divided, horizontally disposed airstreams.

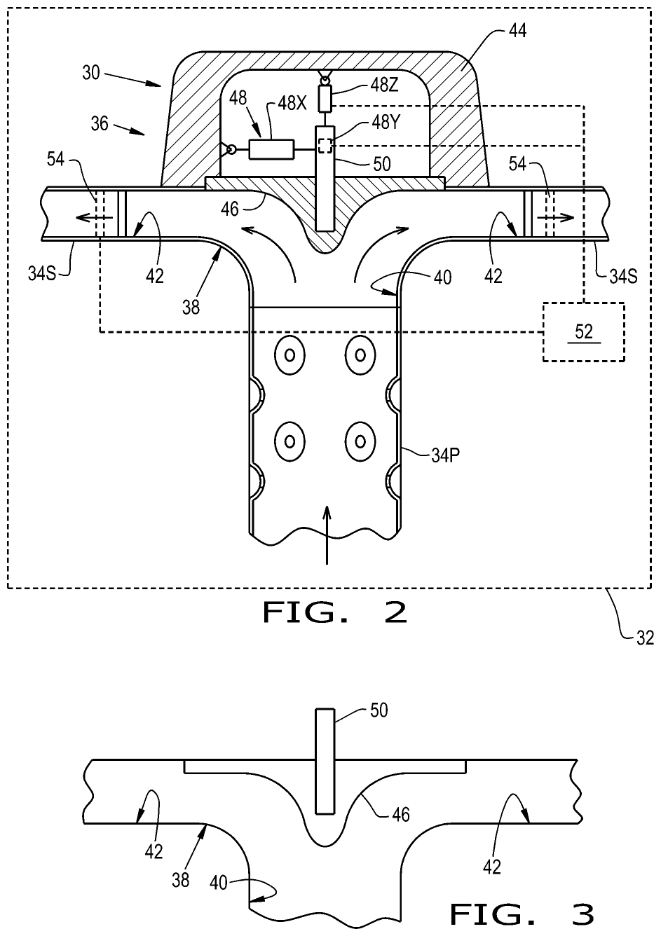

Referring now to FIGS. 2-5, there is shown a pneumatic distribution system 30 according to an exemplary embodiment of the present invention. The pneumatic distribution system 30 can be incorporated into any desired agricultural planting implement 32, for example, a planter, air seeder, or air drill. The agricultural implement 32 may generally include a chassis with a toolbar, multiple row units connected to the toolbar for placing the particulate matter, e.g. seed and/or fertilizer, into the field, a storage tank, a pressure differential fan, and the distribution system 30 that is supported by the toolbar and fluidly couples the storage tank to each row unit (not shown).

The pneumatic distribution system 30 is connected to the toolbar and is configured for distributing the air-entrained particulate matter from the storage tank to each row unit. The pneumatic distribution system 30 includes multiple fluid lines, including a primary fluid line 34P and at least two secondary fluid lines 34S and one or more header(s) 36 that fluidly couple the primary fluid line 34P with the at least two secondary fluid lines 34S. It should be appreciated that the pneumatic distribution system 30 may include multiple headers 36 which can be in the form of primary and/or secondary headers that are interconnected between various fluid lines. As shown, the headers 36 are in the form of secondary headers 36.

Each header 36 can include a header body 38 that has a fluid inlet 40 fluidly coupled to the primary fluid line 34P and at least two fluid outlets 42 fluidly coupled to the at least two secondary fluid lines 34S, a top cover 44 that is connected to the header body 38, a flexible insert 46, and at least one actuator 48 that is operably coupled to the flexible insert 46. Each header 36 may also include a rod 50 interconnected in between the at least one actuator 48 and the flexible insert 46. In operation, the at least one actuator 48 can move the flexible insert 46 to adjust the fluid flow, e.g. airstream, and thereby the flow of particulate matter, through the header body 38. For example, the at least one actuator 48 may adjust the angle and/or position of the rod 50 such that the flexible insert 46 deforms to be in one of a neutral position in which the flexible insert 46 evenly divides the airstream (FIG. 3), a biasing position in which the flexible insert 46 unevenly divides the airstream (FIG. 4), and a restricting position in which the flexible insert 46 at least partially restricts the airstream (FIG. 5).

The header body 38 defines a fluid passageway for allowing the airstream to flow therethrough. The header body 38 can be comprised of a single, uniform part or may be comprised of multiple interconnecting parts. The header body 38 can be composed of any desired material. It should be appreciated that the header body 38 can have two, four, six, eight, or more fluid outlets 42 which respectively connect to corresponding secondary fluid lines 34S.

The top cover 44 is connected to and supported by the header body 38. The top cover 44 can substantially cover or house the flexible insert 46 and the actuator(s) 48. The top cover 44 can be composed of any desired material. The top cover 44 is shown to have a cylindrical shape with a substantially rectangular cross-section; however, the top cover 44 can have any desired shape.

The flexible insert 46 may be located beneath the top cover 44, rigidly connected to the header body 38, and associated with the fluid passageway. The flexible insert 46 can be in the form of an annular insert with an outer periphery and a bulbous region extending downwardly into the header body 38 (unnumbered). The outer periphery of the flexible insert 46 can be rigidly connected to the header body 38, and the rod 50 can be connected to a region of the flexible insert 46 which is adjacent to the bulbous region. The flexible insert 46 can be composed of any desired flexible material, such as an elastomer. The flexible insert 46 can flex or deform upon actuation of the actuator(s) 48 so that the bulbous region of the flexible insert 46 can block or otherwise obstruct a portion of the fluid passageway within the header body 38 in order to control the airstream.

The at least one actuator 48 can be operably coupled with the flexible insert 46 by way of the rod 50 and can move the flexible insert 46 to control the airstream. The at least one actuator 48 can include one, two, three or more actuators. As shown, the at least one actuator 48 includes three actuators 48X, 48Y, 48Z for respectively adjusting the angle and/or the position of the rod 50. The actuators 48X, 48Y, 48Z can be respectively associated with the X, Y, and Z axes of a Cartesian coordinate system. The actuators 48X, 48Y, 48Z can be located underneath the top cover 44 and pivotally coupled with the inside of the top cover 44, the header body 38, and/or the upper portion of the rod 50. For example, the actuators 48X, 48Y, 48Z can be pivotally coupled to the top cover 44 and rod 50 by way of ball-bearing and/or hinged connections. As shown, the header 36 includes a rod 50; however, it is conceivable that the actuator(s) 48 can be directly coupled with the flexible insert 46. Each actuator 48X, 48Y, 48Z can be in the form of any desired actuator, for example, a hydraulic or pneumatic cylinder, a motor, e.g. a servo or stepper motor, and/or biasing member, such as a compression spring. As shown, the actuators 48X, 48Y, 48Z are in the form of pneumatic cylinders.

The rod 50 is connected in between the actuators 48X, 48Y, 48Z and the flexible insert 46. The rod 50 can pivotally and/or rigidly coupled with the actuators 48X, 48Y, 48Z and flexible insert 46. In the present invention, the rod 50 is at least partially embedded within the flexible insert 46. For example, a portion of the rod 50 or approximately half of the rod 50 can be embedded within the flexible insert 46. Thereby, the rod 50 is pivotally connected to the actuators 48X, 48Y, 48Z and is fixedly attached to the flexible insert 46. The rod 50 is shown as a cylinder; however, the rod 50 can have any desired shape. The rod 50 can be composed of any desired material, such as metal or plastic.

In another exemplary embodiment, the pneumatic distribution system 30 can include a controller 52 and at least two feedback sensors 54. The controller 52 is operably coupled with the actuator(s) 48X, 48Y, 48Z and the at least two feedback sensors 54 by a wired and/or wireless connection. The controller 52 can automatically actuate, individually or collectively, the actuator(s) 48X, 48Y, 48Z upon feedback data received from the sensors 54. The controller 52 can be incorporated into the control system of the agricultural vehicle or the agricultural implement 32. The controller 52 may be in the form of any desired electronic control unit (ECU). The controller 52 may include software code or instructions which are tangibly stored on a tangible computer readable medium, e.g. a computer hard drive, an optical medium, solid-state memory, such as a flash memory, or other storage media known in the art. Thus, any of the functionality performed by the controller 52 described herein may be implemented in software code or instructions which are tangibly stored on the tangible computer readable medium. It should be appreciated that the controller 52 may operably connected to multiple headers 36 which are supported by the agricultural implement 32.

The sensors 54 can be disposed in each secondary fluid line 34S or fluid outlet 42 of the header body 38. Since the sensors 54 measure the fluid flow exiting the header body 38, the number of sensors 54 directly corresponds with the number of fluid outlets 38. The sensors 54 can be in the form of any desired feedback sensors, for example, pressure, particle, and/or electrostatic sensors that provide feedback data to the controller 52.

In operation, the controller 52 can control each actuator 48X, 48Y, 48Z to adjust the angle and/or position of the rod 50 such that flexible insert 46 deforms in between the neutral position (FIG. 3), the biasing position (FIG. 4), and the restricting position (FIG. 5). In the neutral position, the actuators 48X, 48Y, 48Z can be maintained in a neutral state so that the flexible insert 46 is maintained to evenly divide the airstream among the fluid outlets 42. Additionally, in the neutral position, the flexible insert 46 may not be deformed or the flexible insert 46 may be partially deformed. In the biasing position, the controller 52 can actuate one or more of the actuators 48X, 48Y, 48Z so that the airstream is dynamically biased among the fluid outlets 42. For instance, the actuator 48X can be actuated by the controller 52 to move the upper end of the rod 50 closer to one side of the header 36 so that the lower end of the rod 50, and thereby the bulbous region of the flexible insert 46, moves to the opposite side of the header 36 to restrict or obstruct the airstream flowing to one or more fluid outlets 42 at the opposite side of the header 36 (FIG. 4). In the biasing position, the flexible insert 46 can partially or completely obstruct the airstream flowing into one of the fluid outlets 42. In the restricting position, the controller 52 can actuate one or more of the actuators 48X, 48Y, 48Z, such as just the actuator 48Z, in order to deform the flexible insert 46 to at least partially obstruct the fluid passageway within the header body 38. For instance, the flexible insert 46 can be moved downwardly toward the fluid inlet 40. In this regard, the flexible insert 46 can trim the airstream resistance in a particular header 36. Further, the controller 52 can equalize flow characteristics across several headers 36. It should be appreciated that the flexible insert 46 can be deformed to substantially or completely obstruct the airflow to all of the fluid outlets 42.

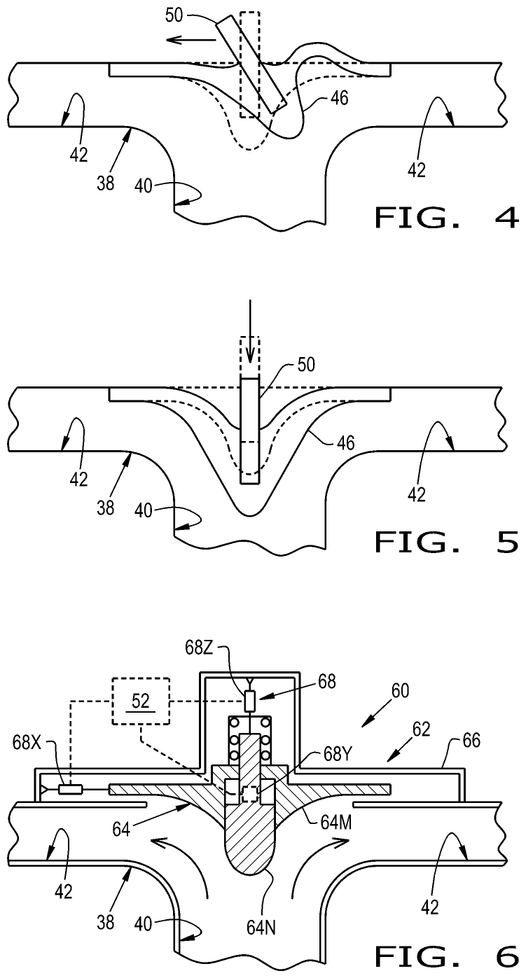

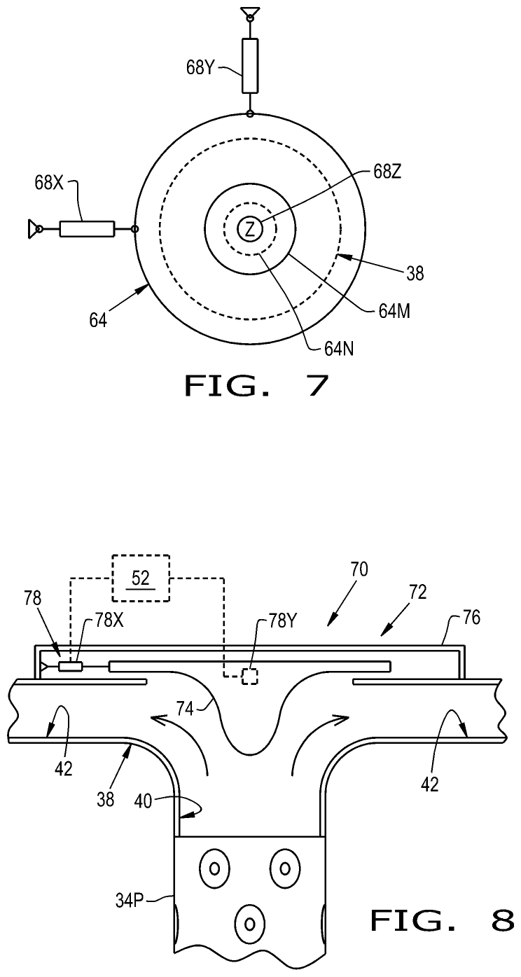

Referring now to FIGS. 6-7, there is shown another embodiment of a pneumatic distribution system 60 which can be incorporated to an agricultural planting implement as discussed above. The pneumatic distribution system 60 can include a header 62, which may be substantially similar to the header 36 as discussed above, except that the header 62 includes a rigid insert 64 instead of the flexible insert 46, a top cover 66, and at least one actuator 68, such as actuators 68X, 68Y, 68Z. Thereby, like components have been identified with like reference numerals. Additionally, the pneumatic distribution system 60 may also include the controller 52 and the sensors 54 as discussed above (only the controller 52 is shown).

The rigid insert 64 is located beneath the top cover 66, moveably connected to the header body 38, and associated with the fluid passageway of the header body 38. The rigid insert 64 can be in the form of a rigid sliding plate 64, which slides relative to the header body 38. For example, the sliding plate 64 can be slideably mounted to the header body 38. In more detail, the rigid insert 64 may include a main body 64M and a nose 64N moveably coupled with the main body 64M. The main body 64M can be slideably connected to the header body 38 in that the main body 64M may rest directly on top of the header body 38, or one or more seals or bearings may be used to mount the main body 64M to the header body 38. The rigid insert 64 can be composed of any desired substantially rigid material, such as a metal or plastic material. Alternatively, the rigid insert 64 may be composed of a deformable material.

The first and second actuators 68X, 68Y are respectively coupled with the main body 64M for respectively sliding the main body 64M relative to the header body 38. The third actuator 68Z is coupled with the nose 64N for adjusting a vertical position of the nose 64B relative to the main body 64M. The main body 64M may have a hole or recess for partially housing and receiving the nose 64N. It should be appreciated that the actuators 68X, 68Y, 68Z can be interconnected between the top cover 66 and/or the header body 38 and the main body 64M and nose 64B, respectively. Similarly to the actuators 48X, 48Y, 48Z of the header 36, the actuators 68X, 68Y, 68Z may be in the form of any desired actuators. For instance, the actuator 68Z may include a pneumatic cylinder and a biasing member disposed in a corresponding housing around the upper end of the nose 64N.

In operation, the controller 52 can actuate one or more of the actuators 68X, 68Y, 68Z to slide and lower or raise the rigid insert 64 between a neutral position in which the rigid insert 64 evenly divides the airstream, a biasing position in which the rigid insert 64 unevenly divides the airstream, and a restricting position in which the rigid insert 64 at least partially restricts the airstream. For example, the actuator 68X can slide the main body 64M of the rigid insert 64 to one side of the header body 38 and the actuator 68Z can lower the nose 64N toward the fluid inlet 40 such that the airstream flowing toward certain fluid outlet(s) 42 is obstructed. Additionally, for example, in the restricting position, the nose 64N can be lowered to at least partially restrict the airstream, such as substantially or completely blocking the airstream, within the header body 38.

Referring now to FIG. 8, there is shown another embodiment of a pneumatic distribution system 70 which can be incorporated to an agricultural planting implement. The pneumatic distribution system 70 can include a header 72, which may be substantially similar to the header 36 as discussed above, except that the header 72 includes a rigid insert 74 instead of the flexible insert 46, a top cover 76, and at least one actuator, such as two actuators 78X, 78Y. Thereby, like components have been identified with like reference numerals. Additionally, the pneumatic distribution system 70 may also include the controller 52 and the sensors 54 as discussed above.

Similarly to the rigid sliding plate 64, the rigid insert 74 can also slide relative to the header body 38. The rigid insert 74 can have a uniform body with a downwardly extending bulbous member (unnumbered). The rigid insert 74 does not include a moveably attached nose as in the header 62 discussed above. Thereby, the rigid insert 74 does not slide or move downwardly toward the fluid inlet 40 of the header body 38. The actuators 78X, 78Y can be interconnected in between the top cover 76 and/or header body 38 and the rigid insert 74. The two actuators 78X, 78Y adjust the position of the rigid insert 74 so that the rigid insert 74 slides between a neutral position in which the rigid insert 74 evenly divides the airstream and a biasing position in which the rigid insert 74 unevenly divides the airstream.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A pneumatic distribution system for an agricultural implement, comprising:
a plurality of fluid lines including a primary fluid line and at least two secondary fluid lines; and
at least one header fluidly coupling the primary fluid line with the at least two secondary fluid lines, and including:
a header body having a fluid inlet fluidly coupled to the primary fluid line and at least two fluid outlets fluidly coupled to the at least two secondary fluid lines, and the header body defining a fluid passageway for allowing an airstream to flow therethrough;
a top cover connected to the header body;
an insert located beneath the top cover and associated with the fluid passageway; and
at least one actuator operably coupled with the insert and configured for moving the insert to control the airstream.

2. The pneumatic distribution system of claim 1, wherein the insert is in the form of a flexible insert that is rigidly connected to the header body, the at least one header further includes a rod interconnected in between the at least one actuator and the flexible insert, and the at least one actuator adjusts at least one of an angle and a position of the rod such that the flexible insert deforms to be in one of a neutral position in which the flexible insert evenly divides the airstream, a biasing position in which the flexible insert unevenly divides the airstream, and a restricting position in which the flexible insert at least partially restricts the airstream.

3. The pneumatic distribution system of claim 2, wherein the at least one actuator includes three actuators for respectively adjusting at least one of the angle and the position of the rod.

4. The pneumatic distribution system of claim 2, wherein the rod is at least partially embedded within the flexible insert.

5. The pneumatic distribution system of claim 1, wherein the insert is in the form of a rigid insert slideably connected to the header body and the rigid insert includes a main body and a nose moveably coupled with the main body.

6. The pneumatic distribution system of claim 5, wherein the at least one actuator includes a first actuator, a second actuator, and a third actuator such that the first and second actuators are respectively coupled with the main body for respectively sliding the main body relative to the header body, and the third actuator is coupled with the nose for adjusting a vertical position of the nose relative to the main body so that the rigid insert moves between a neutral position in which the rigid insert evenly divides the airstream, a biasing position in which the rigid insert unevenly divides the airstream, and a restricting position in which the rigid insert at least partially restricts the airstream.

7. The pneumatic distribution system of claim 1, wherein the insert is in the form of a rigid sliding plate which slides relative to the header body, and the at least one actuator is in the form of two actuators, which are pivotally coupled to the top cover and the rigid sliding plate, such that the two actuators adjust a position of the rigid sliding plate so that the rigid sliding plate slides between a neutral position in which the rigid sliding plate evenly divides the airstream and a biasing position in which the rigid sliding plate unevenly divides the airstream.

8. The pneumatic distribution system of claim 1, wherein the at least one actuator is located underneath the top cover and is pivotally connected to the top cover and the rigid insert.

9. The pneumatic distribution system of claim 1, further including a controller operably coupled to the at least one actuator and configured for actuating the at least one actuator.

10. The pneumatic distribution system of claim 9, further including at least two feedback sensors respectively disposed within the at least two secondary fluid lines and operably coupled to the controller.

11. A pneumatic distribution system for an agricultural implement, comprising:
a plurality of fluid lines including a primary fluid line and at least two secondary fluid lines; and
at least one header fluidly coupling the primary fluid line with the at least two secondary fluid lines, and including:
a header body having a fluid inlet fluidly coupled to the primary fluid line and at least two fluid outlets fluidly coupled to the at least two secondary fluid lines, and the header body defining a fluid passageway for allowing an airstream to flow therethrough;
a top cover connected to the header body;
a rigid insert located beneath the top cover, slideably connected to the header body, and associated with the fluid passageway; and
at least one actuator pivotally coupled with the rigid insert and configured for moving the rigid insert to control the airstream.

12. The pneumatic distribution system of claim 11, wherein the rigid insert includes a main body and a nose moveably coupled with the main body.

13. The pneumatic distribution system of claim 12, wherein the at least one actuator includes a first actuator, a second actuator, and a third actuator such that the first and second actuators are respectively coupled with the main body for respectively sliding the main body relative to the header body, and the third actuator is coupled with the nose for adjusting a vertical position of the nose relative to the main body so that the rigid insert moves between a neutral position in which the rigid insert evenly divides the airstream, a biasing position in which the rigid insert unevenly divides the airstream, and a restricting position in which the rigid insert at least partially restricts the airstream.

14. The pneumatic distribution system of claim 11, wherein the rigid insert is in the form of a rigid sliding plate which slides relative to the header body.

15. The pneumatic distribution system of claim 14, wherein the at least one actuator is in the form of two actuators, which are pivotally coupled to the rigid sliding plate, such that the two actuators adjust a position of the rigid sliding plate so that the rigid sliding plate slides between a neutral position in which the rigid sliding plate evenly divides the airstream and a biasing position in which the rigid sliding plate unevenly divides the airstream.

16. The pneumatic distribution system of claim 11, further including a controller operably coupled to the at least one actuator and configured for automatically actuating the at least one actuator.

17. The pneumatic distribution system of claim 16, further including at least two feedback sensors respectively disposed within the at least two secondary fluid lines and operably coupled to the controller.

18. A method for distributing a particulate matter in an agricultural implement, comprising the steps of:
providing a pneumatic distribution system including a plurality of fluid lines including a primary fluid line and at least two secondary fluid lines and at least one header fluidly coupling the primary fluid line with the at least two secondary fluid lines, and including a header body having a fluid inlet fluidly coupled to the primary fluid line and at least two fluid outlets fluidly coupled to the at least two secondary fluid lines, and the header body defining a fluid passageway for allowing an airstream to flow therethrough, a top cover connected to the header body, an insert located beneath the top cover, connected to the header body, and associated with the fluid passageway, and at least one actuator operably coupled with the insert;
maintaining the insert in a neutral position by maintaining a neutral state of the at least one actuator so that the insert evenly divides the airstream;
moving the insert into a biasing position by adjusting the at least one actuator so that the insert unevenly divides the airstream; and
moving the insert into a restricting position by adjusting the at least one actuator so that the insert at least partially restricts the airstream.

19. The method of claim 18, wherein the insert is in the form of a flexible insert, the at least one header further includes a rod interconnected in between the at least one actuator and the flexible insert, and the at least one actuator includes three actuators for respectively adjusting at least one of an angle and a position of the rod.

20. The method of claim 18, wherein the insert is in the form of a rigid insert, the rigid insert includes a main body and a nose moveably coupled with the main body, and the at least one actuator includes a first actuator, a second actuator, and a third actuator such that the first and second actuators are respectively coupled with the main body for respectively sliding the main body relative to the header body, and the third actuator is coupled with the nose for adjusting a vertical position of the nose relative to the main body.
